(19) United States
(12) Patent Application Publication
(10) Pub. No.: US 2007/0023571 A1
(43) Pub. Date: Feb. 1, 2007

(54) Quiet airplane configuration

(76) Inventors: Ronald T. Kawai, Rancho Palos Verdes, CA (US); Richard C. Odle, Long Beach, CA (US)

Correspondence Address: ERNEST CARAVALHO, 1200 S. COURTHOUSE RD., APT. 838, ARLINGTON, VA, 22204, US

(21) Appl. No.: 11/183,041

(22) Filed: Jul. 15, 2005

(51) Int. Cl. B64C 1/00

(52) U.S. Cl. 244/119

(57) ABSTRACT

A blended wing aircraft reduces forward, aft, and sideline flyover noise and heat energy by reflecting it upward using the wing and vertical stabilizers positioned just outboard of the engines. The engines are located on top of the wing and forward of the trailing edge of the wing with the aft portion of the engines located over the wing. The nozzle exit perimeter is increased and shaped to increase shear and create vortices to move noise generation over the wing to cause the noise to be reflected upward off the wing and upward off of the canted vertical stabilizers. Engine thrust reversers cause the forwardly mounted engine's thrust to be directed toward the front of the aircraft in such a way as to create a download forward of the main landing gear to also secure the front landing gear.

### FIELD OF THE INVENTION

The present invention relates to the arrangement of propulsion systems and vertical aerodynamic flight control surfaces of an aircraft to reduce ground detectable acoustic signatures and infra red heat signatures of the aircraft.

### BACKGROUND OF THE INVENTION

Various configurations for the exterior components of an aircraft are known. Many of such aircraft include different configurations of control components such as engines, wings, elevators, ailerons, and rudders. Related to the configuration of such components, every aircraft has a flyover noise signature, a sideline noise signature, known as acoustic signatures, and an infrared heat signature associated with it. The intensities of such signatures are dependent upon the specific component configuration of the specific aircraft.

For many commercial applications, the current flyover noise, sideline noise, and infrared signatures are acceptable and meet specific airport and FAA requirements. However, with increasingly more air traffic growth, the number of airplanes and flight operations with local government regulations and restrictions will be limiting the ability to expand services for public demand. With increasing sizes of engines, airplanes, and payloads, commercial aircraft will reach or negatively exceed certain noise limitations. Recent events have also shown a need for future military airplanes that lower noise to reduce detection from enemy personnel when the airplane may not be visible. Further terrorist threats from shoulder launched heat seeking missiles posses another factor for reducing infra red signatures and contributes to fear of flying. In this regard, transport aircraft do not have their major exterior control components advantageously located to significantly reduce such noise and infrared signatures. In this regard, transport aircraft do not have their engines located such that certain horizontal and vertical portions of the aircraft act as barriers to limit the flyover noise signature, the sideline noise signature, and the infrared signature associated with an aircraft. Furthermore, due to the current locations of engines on aft fuselage mounted engine configurations relative to the landing gear, during reverse thrusting, aircraft may have a tendency to experience nose wheel lift off during reverse thrusting, which limits the level of reverser thrust possible.

A need remains in the art for an aircraft that overcomes the limitations associated with the prior art, including but not limited to those limitations discussed above. Therefore, a need remains for an aircraft having engines located on top of the aircraft to shield noise and heat, an aircraft having vertical aerodynamic flight control surfaces to provide lateral shielding of engine noise and heat, and that also provides reflection of noise and heat upward and away from the ground.

### SUMMARY OF THE INVENTION

The teachings of the present invention provide an aircraft that reduces acoustic signature, most notably flyover and sideline noise, and infra red signature. The aircraft engines are located forward of the aircraft trailing edge and elevons of the aircraft on top of the blended wing and fuselage. Vertical aerodynamic flight control surfaces are located at least on each side of the engines to provide lateral shielding to reflect noise and heat upward and away from the aircraft and the ground. Because the jet engines may be located on top and towards the center of a blended wing body, flyover noise and heat are also shielded by the blended wing body.

Furthermore, the teachings are such to move the exhaust jet noise closer to the engine nozzle exit by increasing the nozzle exit flow shear perimeter and creating vortex generating shapes about the engine perimeter. By moving the noise generation closer to the engine exit, the elevons below and aft of the engines shield noise and reduce the radiant heat generated by the engines. Finally, because the engines are moved forward on the blended wing, a reactive downward force is generated against the top of the blended wing forward of the main landing gear when, upon landing, reverse thrust meets onrushing air and creates a vertical wall jet. The vertical wall jet reduces aircraft lift while the downward force generates a favorable nose down pitching moment about the main landing gear.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an aircraft depicting a wing, engines, and vertical aerodynamic flight control surface configurations according to teachings of the present invention;

FIG. 2 is plan view of an aircraft depicting the direction of noise as it exits an aircraft engine;

FIG. 3 is a plan view of a configuration of vertical stabilizers, engines, and the wing of an aircraft, depicting the direction of noise as it exits the engines;

FIG. 4 is side view of an aircraft in a take off and approach position depicting noise paths resulting from the aircraft engines;

FIG. 5 is a side view of an aircraft during landing depicting air force paths from air currents due to aircraft forward motion and thrust reversing;

FIG. 6a is a perspective view of an aircraft engine outlet having scalloped shaped perimeters;

FIG. 6b is a perspective view of an aircraft engine outlet having daisy shaped perimeters having a scalloped effect;

FIG. 6c is a perspective view of an aircraft engine outlet having vaned perimeters;

FIG. 6d is a perspective view of an aircraft engine outlet having flapped perimeters; and

FIG. 6e is a perspective view of an aircraft engine outlet having a combination of flapped and vaned perimeters.

### DETAILED DESCRIPTION OF THE PREFERRED EMBODIMENTS

The following description of the preferred embodiments is merely exemplary in nature and is in no way intended to limit the invention, its application, or uses.

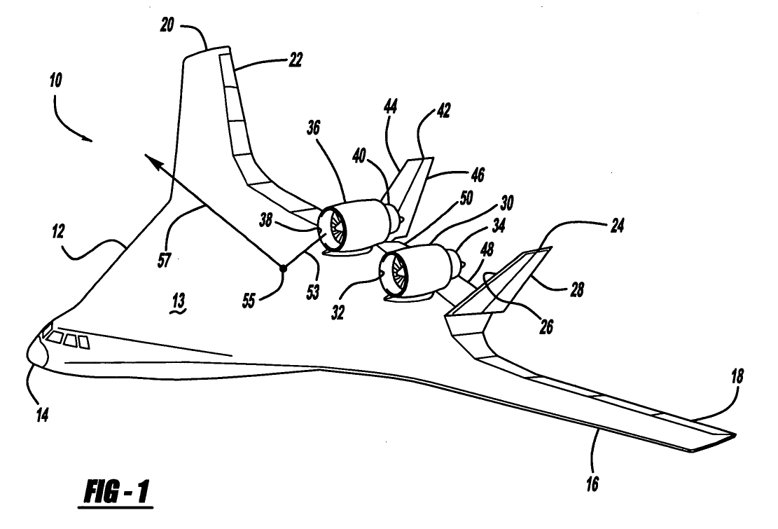

With reference to FIG. 1, an aircraft and its component configuration according to the teachings of the present invention is generally depicted at reference numeral 10. With continued reference to FIG. 1, the aircraft 10 shown is a blended wing body (BWB) aircraft and is used throughout the description as an example of an aircraft upon which the configuration of the teachings of the present invention could be used; however, other types of aircraft, such as traditional tube and wing configurations could be configured similarly to the teachings of the present invention.

Continuing with reference to FIG. 1, the aircraft 10 has a nose section 14 at the leading end of a blended fuselage and wing 12. The blended fuselage and wing 12 has an expansive, generally flat top wing surface area 13 upon which other structural components are mounted. The fuselage and wing 12 tapers at its sides to form a more traditional-looking left wing 16 and a right wing 20. The left wing may have a left elevon 18 fitted into it while the right wing 20 may have a right elevon 22 fitted into it. The components mounted or fitted onto the top of the wing surface area 13 consist of a left engine 30 having an engine inlet 32, and an engine outlet 34. Likewise, there may be a right engine 36 having an engine inlet 38 and an engine outlet 40. While the aircraft of FIG. 1 depicts dual engines 30, 36, an aircraft is conceivable such that it could have any number of engines depending upon the overall size of the aircraft and the thrust necessary to generate enough speed to provide adequate lift for the aircraft.

Continuing with reference to FIG. 1, a left vertical stabilizer 24 has a stabilizer leading edge 26 and a stabilizer trailing edge 28, while a right vertical stabilizer 42 has a stabilizer leading edge 44 and a stabilizer trailing edge 46. Located adjacent the stabilizers 24, 42 are a left large pitch control elevon 48 and a right large pitch control elevon 50. Positioning of the engines 30, 36 the vertical stabilizers 24, 42, the large pitch control elevons 48, 50, relative to the wing surface area 13 is such to achieve advantages of the invention. Such positioning will now be described.

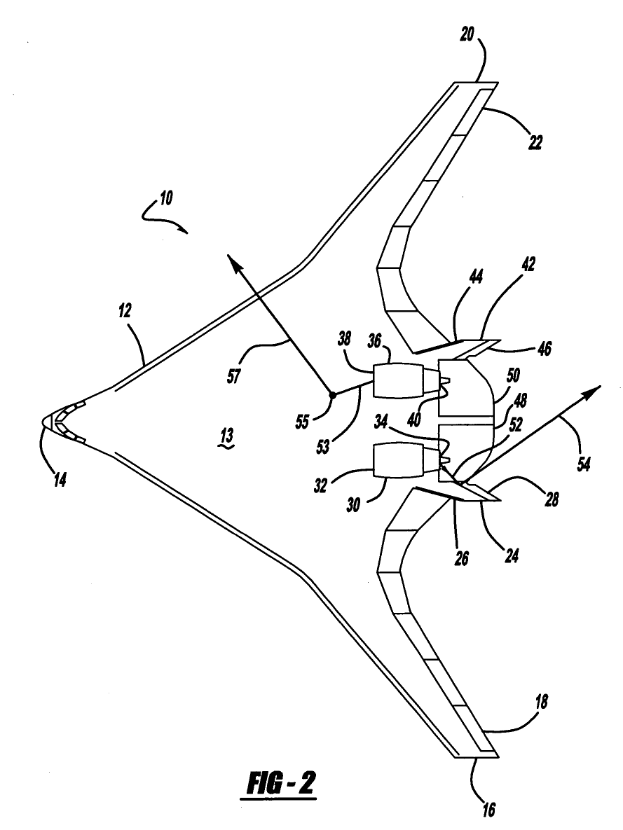

With continued reference to FIGS. 1 and 2, the engines 30, 36 are positioned forward of the large pitch control elevons 48, 50. More specifically, both the engine inlets 32, 38 and the engine outlets 34, 40 are positioned forward of the large pitch control elevons 48, 50. Because a similar effect is experienced with each engine 30, 36, only one engine 30 will be used in portions of the discussion. Those skilled in the art should understand that because of the symmetrical positioning of the engines relative to a longitudinal centerline of the aircraft 10, symmetrical effects may be experienced. With reference to only the left engine 30, because the engine outlet 34 is positioned forward of the large pitch elevon 48, and adjacent the center portion of the vertical stabilizer 24, noise and heat emitted from the engine outlet 34 according to directional line 52 strikes the vertical stabilizer 24. When the noise and heat of directional line 52 strike the vertical stabilizer 24, the noise and heat are laterally shielded from moving outside of, or beyond, the vertical stabilizer 24. Additionally, upon striking the vertical stabilizer 24, the noise and heat will be reflected upward and away from the surface 13 of the aircraft according to directional line 54, because the vertical stabilizer 24 may be canted or pitched away from the engines 30, 36.

Continuing with noise and heat deflection, FIGS. 1 and 2 depict noise and heat deflection from the engine inlet 38 of engine 36. More specifically, directional arrow 53 depicts the path of noise and heat from the engine 36 until it strikes the wing surface area 13 at strike point 55. Since the engine 36 may be on a mounting pod, above the wing surface, the noise and heat may be delivered downward and strike the wing at an angle. Upon striking the wing surface area 13, the noise and heat are reflected at an angle according to direction arrow 57. The advantage of reflecting the noise and heat emitted from the engine inlet upward and away from the aircraft is that the acoustic and heat signatures detected from the ground are reduced or eliminated. The shielding and reflection advantage of the forward propagated inlet noise has been shown by others and as such is not alone new art but is new when for combination with the new arts of aft and sideline noise shielding and reflection advantages described herein for an overall totally quieter airplane.

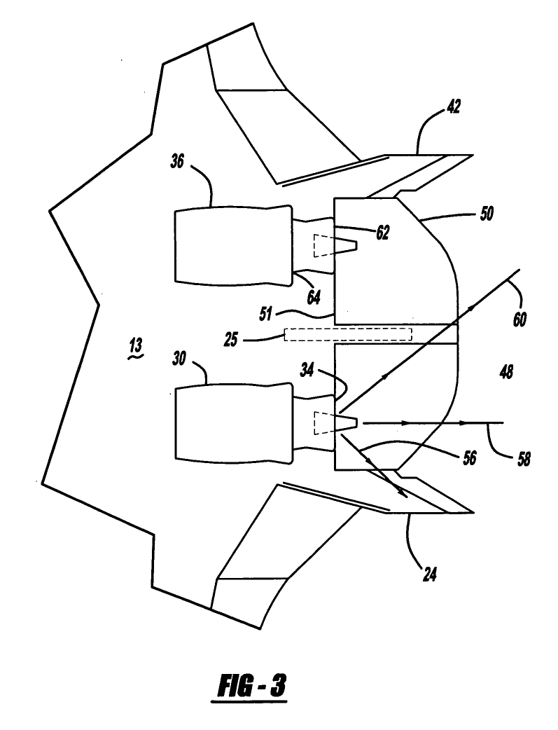

To better understand why the noise and heat of the engines are deflected as they are, a more thorough explanation of the vertical aerodynamic flight control surfaces, that is, the vertical stabilizers 24, 42 is in order. As best depicted in FIGS. 2 and 3, the vertical stabilizer 24 is canted with respect to the wing surface area 13. More specifically, the top of the vertical stabilizer 24 is angled away from the engine 30, permitting deflection of noise waves and heat in an upwardly direction. Furthermore, because the vertical stabilizer 24 is positioned so that the engine exhaust outlet is adjacent the center section of the vertical stabilizer 24, that is, approximately half way between the stabilizer leading edge 26 and the stabilizer trailing edge 28, the vertical stabilizer 24 is able to reflect a generous quantity of the noise and heat exiting the engine 30. However, it should be understood that the vertical stabilizer 24 may be moved for and aft along the top surface of the wing, adjacent the engine 30, to reflect the greatest quantity of noise and heat while maintaining aerodynamic protocol.

Turning to FIG. 3, an enlarged view of the engines 30, 36, vertical stabilizers 24, 42, elevons 48, 50, and the noise and heat generated and emanated from that area is depicted. More specifically, the engine 30 at engine outlet 34 emits noise and heat as depicted by directional lines 56, 58, and 60. As discussed above, noise and heat waves of directional arrow 56 strike vertical stabilizer 24 to shield the noise and heat from radially emanating past the vertical stabilizer 24. Furthermore, the canted vertical stabilizer 24, reflects the noise and heat upward and away from the wing surface area 13, which is also away from the ground. Continuing with reference to FIG. 3, engine 36 is shown with a fan nozzle exit 64 and a core exhaust nozzle exit 62. Internally generated noise emanates out from the fan nozzle exit 64 and core nozzle exit 62. There is also noise generated externally from the engine which is the exhaust jet noise created by the shear from mixing engine exhaust flow with the atmosphere. It is through increases in these exhaust perimeters and shaping to create vortices that govern the downstream distance where exhaust jet noise is generated aft of the engines 30, 36. Simultaneously, increasing flow shear and creating vortices cause the generation of noise to move closer to the engine outlet 62, 64. By moving the exhaust jet noise closer to the engine outlet, the jet noise creating source is situated over the top of the aircraft structure, in accordance with the teachings of the present invention. Thus the internally generated and externally generated noises are favorably shielded and reflected. This forward movement of exhaust jet noise generation creates another benefit of reducing the infra red signature by shortening the hot core exhaust plume to improve shielding with a more rapid dissipation that reduces the radiation source size. With reference to FIG. 3, the aircraft structure may be the large pitch control elevons 48, 50, the strip of wing surface area 49, or the wing surface area 13.

When the engine noise and heat are generated over or just in front of the large pitch control elevons, the noise and heat can easily be deflected upward since, for example, the elevon 50 pivots proximate the elevon leading edge 51. Although noise and heat directed directly toward the elevon 50 is directly deflected upward, the elevon 50 also deflects any noise and heat reflected from the adjacent vertical stabilizers 48, 50. That is, the vertical stabilizers 24, 42 in combination with the pivoting elevons 48, 50, effectively channel noise upward and outward from the aircraft 10. Therefore, the noise and heat generation are moved forward over the aircraft wing surface 13 and elevons 48, 50 by mounting the engines forward of the trailing edge of the aircraft and by increasing the flow shear aft of the engines by increasing the fan and core exhaust nozzle exit perimeters. To increase the exhaust nozzle perimeters and create vortices, the shapes of the exhaust nozzles 62, 64 can be designed in various geometric shapes. For instance, the exhaust nozzle exits 62, 64 can be daisy-shaped, scalloped, vaned, slotted, flapped, or a combination of such shapes to increase the exhaust perimeter and create vortices and thus, increase flow shear and initial flow mixing to move the exhaust jet noise generation forward, closer to the engine. However, although the exit perimeter may be increased, the exit flow area normal to the flow remains.

Although FIG. 3 depicts a small unoccupied wing area 49 between the large pitch elevons 48, 50, the area 49 may be occupied with yet a third vertical stabilizer 25, shown in phantom. A third vertical stabilizer 25, would provide twin surface areas, one on each side of the vertical stabilizer 25, from which noise and heat discharged from the engines 30, 36 could be reflected.

By reducing the flyover noise or acoustic signature according to the above description, more aircraft as well as larger aircraft with larger engines can continue to operate in current airports. Additionally, reduction or elimination of noise as a nuisance will permit air travel growth, in terms of the number of take-offs and landings, from airports without current service as well as of existing airports, and reduce the cumulative community noise exposure around such airports. Additionally, aircraft configured according to the above description may not be penalized with higher landing fees normally associated with noisier airplanes. Finally, many airports limit night landings due to stricter local noise restrictions, which may limit larger and heavier aircraft, such as freighters, from landing at night when air traffic is significantly reduced. The teachings of the present invention may not only permit such night landings by reducing an aircraft's acoustic signature, but permit community acceptable growth.

By reducing the infra red signature of an aircraft according to the above description, infra red threats may be reduced. That is, by reducing or eliminating the infra red signature of an aircraft, the aircraft becomes less susceptible or unsusceptible to infra threats such as ground-launched heat seeking missiles that depend upon an infra red signature for guidance.

Turning to FIG. 4, an aircraft 10 is depicted in a position that is typically experienced during takeoffs and landings. More specifically, the nose section 14 of the aircraft 10 is elevated relative to the tail section. Operatively, and according to the teachings of others and included as a part of the total improvements, the engines 30, 36 emit from their inlets 32, 38, noise and heat, which may be deflected according to the following example scenario. Noise and heat are emitted from an engine 30 of the engines 30, 36 according to directional line 70. Upon striking the top surface of the aircraft 10, the noise and heat are reflected according to directional line 72. Likewise, noise and heat emitted from a different portion of the engine 30 according to directional line 66, strike the top surface of the aircraft 10 at a different angle of incidence than directional line 70. Directional line 68 depicts the reflection of the noise and heat of directional line 66. For each example of the reflection of incidence, the detection of the acoustic and heat signatures on the ground may be reduced or eliminated.

Continuing with reference to FIG. 4, for the teachings of this present invention, noise and heat emitted from the rear of the engine 30 is, as an example, emitted downwardly according to direction line 74. Upon incidence with the elevon 48, noise and heat are reflected upwardly according to directional line 76. Directional lines 74, 76 are shown in phantom because the noise and heat are located between the vertical stabilizers 24, 42, which provide a lateral shield to noise and heat. In the event that the climb angle of the aircraft 10 is steeper than that depicted in FIG. 4, or if the elevons 48, 50 are pivoted upwardly above the surface of the aircraft, then a more aggressive reflecting or shielding of noise and heat will be evident due to the upwardly pointed elevon 48, 50 (not shown).

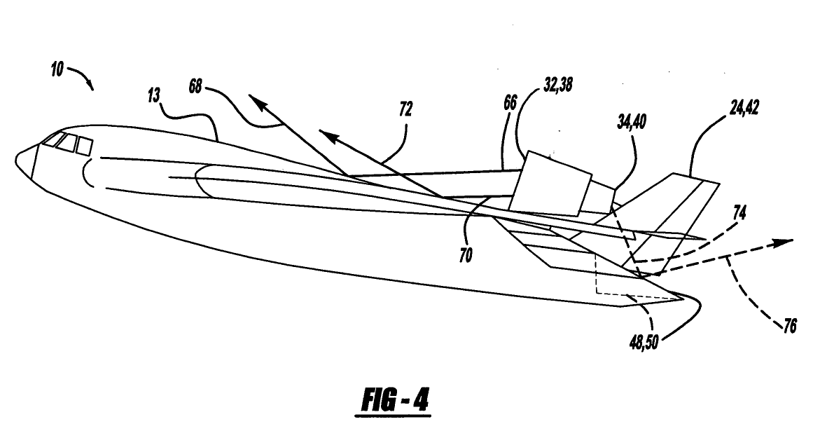

Turning to FIG. 5, an aircraft 10 is shown rolling along in a nearly horizontal position immediately after landing on a runway. During a time period just after landing, the reverse thrusters 78, 79 may be deployed on the engines 30, 36, respectively. Deploying the reverse thrusters 78, 79 causes the reverse thrust noted by the plurality of directional lines 80, to be directed upwardly and forwardly along and above the top surface of the aircraft 10. The reverse thrust airflow effectively eliminates aircraft body surface lift caused by the aircraft moving through air, because the reverse thrust negatively mixes, or intercepts the air approaching the aircraft 10. Additionally, during reverse thrusting, the elevons 48, 50 are in a downward position. The combination of the reverse thrusting and the downward position of the elevons 48, 50 assists in slowing the aircraft 10 with a favorable nose down pitching moment and increased download on the main wheels, thereby increasing braking.

Continuing with reference to FIG. 5, during landing, the reverse thrust directional lines 80 meet oncoming air, depicted by the plurality of directional lines 82. Upon meeting, the reverse thrust 80 and oncoming air 82 are forced upwardly and away from the top surface of the aircraft 10. This upward rush is known as a vertical jet wall. As an equal and opposite reaction to this upwardly forced air, a downward force is depicted by the plurality of downwardly directed directional lines 84. The location of the downward force 84 is an aspect of the teachings of the present invention. More specifically, because the downward force 84 is located between the front landing gear 86 and the main landing gear 88, and more specifically, forward of the main landing gear 88, the aircraft nose is effectively forced down, thereby preventing nose liftoff during reverse thrusting. The downward force 84 causes a moment about the main landing gear 88 that increases the downward force of the front landing gear 86 against the runway. The downward force 84 being shifted forward of the main landing gear 88 is, all else being equal, a result of shifting the engines 30, 36 forward and away from the trailing edge of the aircraft 10, to a location over and on the wing.

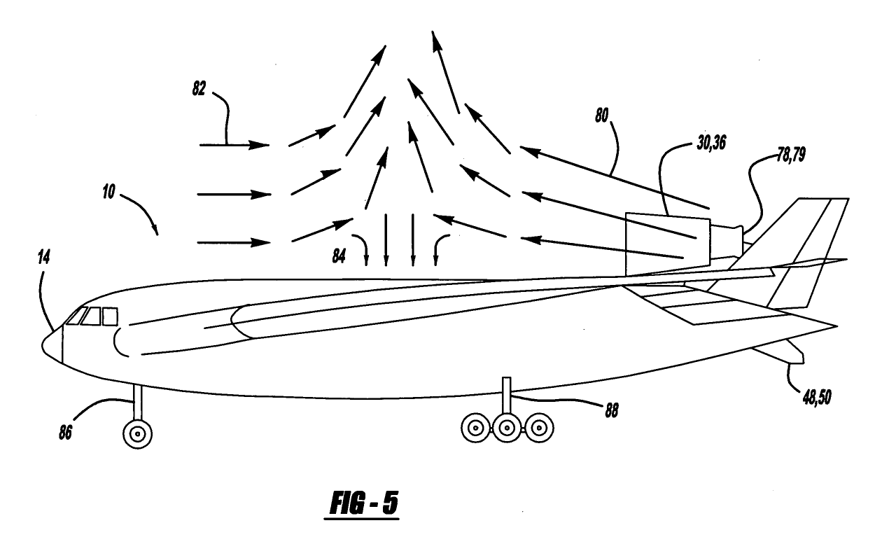

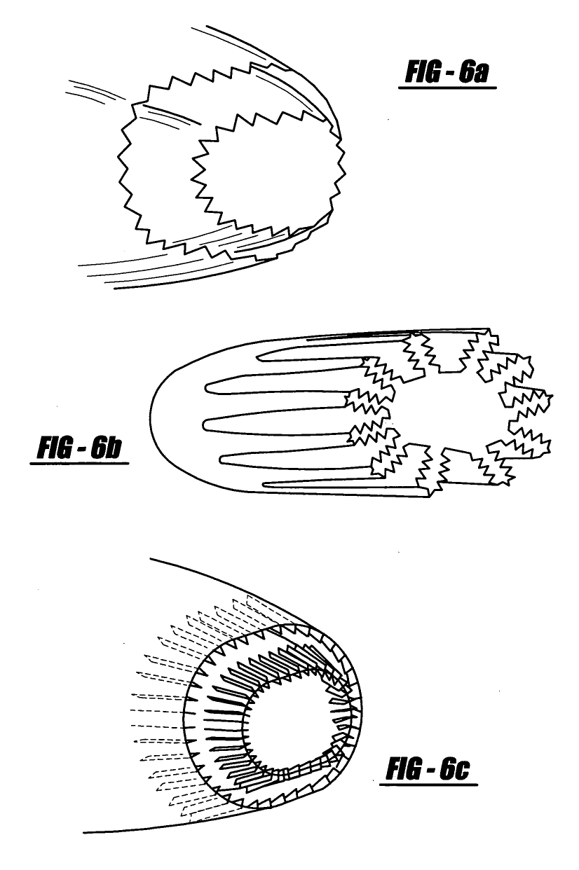

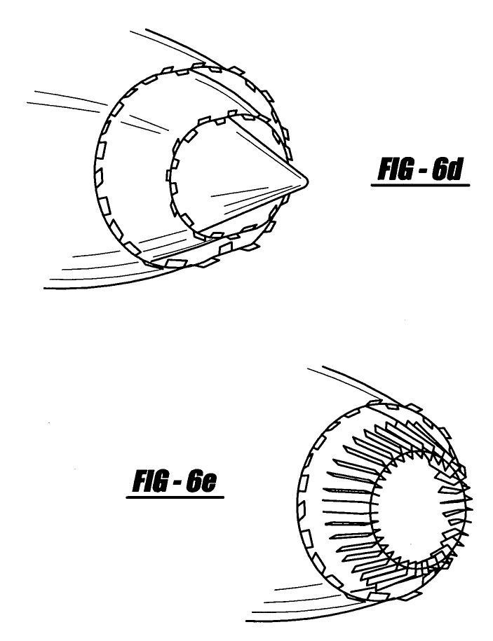

Turning to FIGS. 6a through 6e, aircraft engine exit nozzle perimeters are depicted. As mentioned above, increasing the perimeter and shape of the jet engine nozzle exit may increase the flow shear and create vortices to cause rapid mixing of the exit gases with the air behind the engine. This rapid mixing moves exhaust jet noise generation forward to a location just aft of the engine. By moving the noise generation just aft of the engine, noise shielding can be increased, since the noise is moved forward to a position over the aircraft and between the vertical stabilizers. Various geometric configurations about the nozzle exit perimeter can accomplish the moving and increased mixing. Some examples of these exit nozzles are depicted in FIGS. 6a through 6e.

FIG. 6a is a perspective view of an aircraft engine outlet having a more rectangular as to circular cross section with scalloped shaped perimeters. FIG. 6b is a perspective view of an aircraft engine outlet having a daisy shaped perimeter. The daisy shaped perimeter may also have a scalloped or non-scalloped edge. FIG. 6c is a perspective view of an aircraft engine outlet having vane shaped vortex generators around the perimeters. FIG. 6d is a perspective view of an aircraft engine outlet having flapped shaped vortex generators around the perimeters. Finally, FIG. 6e utilizes a combination of flaps and vanes as vortex generators around the perimeters.

These exit shapes of FIGS. 6a-6e can be used on a fan and core flow separately with the shapes on the core internal to or external to the fan exit nozzle, or on a common exhaust exit. Concerning the jet engines depicted, they can be nearly any type of jet engine, for example, a turbojet, a turbofan, etc. As depicted, by placing geometric shapes about the exhaust perimeters, and by altering the overall exit from that of a circular cross section to that which is largely rectangular in cross section, increasing the vortices and moving them closer to the engine outlet, and over the airplane structure, is possible, which permits noise and heat reflection upward. Moving the vortices and simultaneously the shear flow, mixes the flow in such a fashion to move the noise generation location to the location of the vortices, proximate the engines.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An airplane configuration comprising:
a wing having a trailing edge;
an elevon situated on a top side of the trailing edge;
a pair of vertical stabilizers attached to a top side of the wing; and
an engine having an engine inlet, and an engine outlet at an aft end of the engine, the engine located between the vertical stabilizers, wherein:
the engine outlet is situated forward of the trailing edge of the wing.

2. The airplane configuration of claim 1, wherein the vertical stabilizers are canted away from the engine.

3. The airplane configuration of claim 2, wherein the aft end of the engine is forward the trailing edge of the wing.

4. The airplane configuration of claim 1, wherein an aft end of the engine is located forward of the elevon.

5. The airplane configuration of claim 1, wherein the engine inlet is located forward of the leading edge of the vertical stabilizers.

6. The airplane configuration of claim 1, wherein the top surface of the wing shields noise emanating from the engine inlet and engine outlet.

7. The airplane configuration of claim 1, further comprising:
a third vertical stabilizer positioned between the pair of vertical stabilizers.

8. The airplane configuration of claim 1, further comprising:
a main landing gear located under the wing, wherein during reverse engine thrusting, a downward force is applied forward of the main landing gear.

9. An aircraft comprising:
a wing having a trailing edge;
a pair of canted vertical stabilizers to reflect noise and heat, each having a leading edge and a trailing edge, the vertical stabilizers attached on a top side of the wing proximate to an aircraft body centerline; and
at least one engine having an engine inlet and an engine outlet, the engine mounted between the pair of vertical stabilizers, wherein:
the engine outlet is located forward of the trailing edge of the wing and aft of the leading edge of the vertical stabilizers.

10. The aircraft of claim 9, wherein the engine inlet is located forward of the leading edge of the vertical stabilizers.

11. The aircraft of claim 9, wherein the vertical stabilizers are canted away from the engine to reflect engine noise away from the wing.

12. The aircraft of claim 9, further comprising:
an elevon, wherein exhaust from the engine is discharged over the elevon.

13. The aircraft of claim 10, wherein the engine outlet is located forward of the elevon.

14. The aircraft of claim 11, further comprising:
a third vertical stabilizer located between the pair of vertical stabilizers to facilitate reflection of heat and noise onto the elevon and the canted vertical stabilizers.

15. A blended wing aircraft comprising:
a pair of engines, each having an engine inlet and an engine outlet, the engines located forward of a pair of elevons; and
a pair of vertical stabilizers located outboard of the engines, wherein:
the engines, vertical stabilizers, and elevons are located on the top of the wing, and
the engine outlets are located forward of the elevons.

16. The blended wing aircraft of claim 15, wherein the vertical stabilizers are canted away from the engines to reflect engine noise and heat away from the wing.

17. The blended wing aircraft of claim 15, further comprising:
an engine thrust reverser that directs thrust toward a front of the aircraft that causes a moment about, and a downward force forward upon, a main landing gear.

18. The blended wing aircraft of claim 17, wherein the aircraft wing reflects noise and heat discharging from the front of the engine away from an aircraft surface.

19. The blended wing of claim 17, wherein the engine outlet has a scalloped edge to generate vortices.

20. The blended wing of claim 17, wherein the engine outlet has a plurality of vanes to generate vortices.
